(19) United States
(12) Patent Application Publication
(10) Pub. No.: US 2002/0130261 A1
(43) Pub. Date: Sep. 19, 2002

(54) Method of preparing a slurry for monitoring particle size distribution

(76) Inventor: Kohei Tarutani, Paris (JP)

Correspondence Address: E. Joseph Gess, Esq., BURNS, DOANE, SWECKER & MATHIS, L.L.P., P.O. Box 1404, Alexandria, VA, 22313-1404, US

(21) Appl. No.: 09/803,935

(22) Filed: Mar. 13, 2001

(51) Int. Cl. G21K 7/00; G01N 23/00

(52) U.S. Cl. 250/307

(57) ABSTRACT

Provided is a process of preparing a slurry sample containing abrasive particles useful in CMP for observation with a scanning electron microscope in order to monitor particle size distribution. The process comprises providing a slurry sample containing abrasive particles useful in CMP, and placing a sample of the slurry on an iso-pore filter to thereby remove liquid from the slurry.

### BACKGROUND OF THE INVENTION

1. Field of the Invention

The present invention relates to a method of preparing a sample of a slurry, and in particular a CMP slurry, for monitoring particle size distribution with a scanning election microscope (SEM). More specifically, the present invention relates to a method of pre-treating the slurry with a membrane filter to insure the slurry is ready for accurate analysis by a scanning electron microscope.

2. Description of the Related Art

In the semiconductor device manufacturing industry, chemical-mechanical planarization (CMP) is used to planarize and reduce the contamination of structures overlying the semiconductor substrate. Most semiconductor manufacturers use CMP to planarize dielectric layers and metal structures. The most common approach used in the CMP process is to attach a semiconductor wafer to a carrier (which may or may not rotate) via a mounting pad and to polish the exposed surface of the wafer by bringing it into contact with a polishing pad. The mechanical abrasion between the wafer surface and the polishing pad results in the planarization of the wafer surface.

To aid in the planarization of the wafer surface and to transport disengaged wafer particles from the wafer surface, a slurry is usually introduced between the wafer surface and the polishing pad. The CMP slurries typically include abrasive particles and a medium in which the abrasive particles are suspended. The abrasive particles used in the CMP slurry are generally comprised of silicon oxide, but other materials have been proposed, e.g., aluminum oxide and cerium oxide. In addition, oxidizing agents are often blended with the slurry either at the point of use or on-site as per customer specifications. Surfactants can also be added to the slurry to enhance the wettability of the surface being polished and to reduce vibrations during planarization. The chemical components of the slurry react with the wafer surface, thereby making the wafer more easily polishable and to have better selectivity between a wanted polish layer and an unwanted polish layer.

Agglomerated particles in the CMP slurry have a severe impact on the quality of the CMP (Chemical Mechanical Planarization) process. The state of agglomeration is characterized by the particle size distribution, and various different techniques exist which have been used for measuring the particle size distribution. For example, the Accusizer 780 and Nicomp 380 particle size analyzers are commercially available analyzers that have been used to perform the characterization service. While the measurements obtained from such instruments are extremely interesting and can be used to provide an indication of the state or appropriateness of the slurry, they do not fully represent the morphology of the particles within the slurry. Agglomerates are made up of multiple spheres which are interpreted by the analyzers as their optical equivalent diameter (i.e. the analyzer represents the entire agglomerate as a sphere). As it is extremely unlikely that the agglomerates are in fact always spheres, and the shape of the agglomerates most likely have an impact on process defects (scratches, micro scratches etc.), it is preferable and desirable to obtain a visual observation of the particle morphology by a Scanning Electron Microscope (SEM).

SEM observation can be used in the calibration of a particle size distribution analyzer, and in understanding a potential problem with incoming slurry quality and a slurry distribution system by observing the form of agglomerated particles. However, the observation cannot be done directly, because CMP slurries normally have a very high concentration of particles, and a great deal of moisture. An individual particle of the slurry has a size ranging from 10 or more nms to a few hundred nm, so a magnification of several tens of thousands is necessary. In the case of a tungsten cathode filament SEM, several tens of thousands magnification is the limit of the instrument. Careful tuning/optimization would be needed, therefore, when using a conventional SEM like a tungsten cathode filament instrument. This can make obtaining an accurate analysis difficult.

Before a slurry sample is observed, a dilution of the sample is needed to allow independent particles to be observed. However, too much dilution can change the character and form of the individual particles in the agglomeration of particles. Also, moisture removal from the sample is needed so it might be appropriately observed by a SEM. Normally, a cryogenic SEM is used for this kind of application, however a cryogenic SEM is not a typical or conventional instrument, and its use in observation is time consuming and requires lengthy periods of time.

It is therefore an object of the present invention to provide a simple method of preparing a CMP slurry sample of agglomerated particles for observation using a scanning electron microscope.

It is another object of the present invention to provide a method which quickly removes moisture from a CMP slurry sample.

Yet another object of the present invention is to provide such a method which can also control the particle concentration of the slurry sample so it is suitable for observation by a scanning electron microscope, without changing the characteristics of the particle agglomeration in the slurry sample.

Still another object of the present invention is to provide such a method which is quick and allows one to use a conventional, non-cryogenic SEM, for observation and characterization.

These and other objects of the present invention will become apparent to the skilled artisan upon a review of the specification, the figures of the drawing, and the claims appended hereto.

### SUMMARY OF THE INVENTION

The foregoing objectives are realized by the present invention in using a membrane filter to prepare a slurry sample for observation by a scanning electron microscope. The methods of the present invention provide for ease of operation, are quick and reliable, and do not need special, expensive instrumentation such as a cryogenic scanning electron microscope.

In one embodiment, the present invention provides a process of preparing a slurry sample containing abrasive particles useful in CMP for observation with a scanning electron microscope in order to monitor particle size distribution. The process comprises providing a slurry containing abrasive particles useful in CMP, and placing, e.g., dropwise, a sample of the slurry on an iso-pore filter to thereby remove most of the liquid from the slurry by means of the filter.

In another embodiment, the present invention provides a process of preparing a slurry sample containing abrasive particles useful in CMP for observation with a scanning electron microscope in order to monitor particle size distribution, which process comprises providing a slurry of abrasive particles useful in CMP and detecting the sample of the slurry to a maximum factor of 1000 times. Some of the diluted slurry sample is then placed dropwise onto a bottom iso-pore filter, with the sample being covered with a top iso-pore filter. The droplet is then wiped or smeared between the two filters to thereby create samples for observation on the bottom and top filters of different particle concentrations.

In each of the foregoing methods, it is most preferred that a blotter medium be used conjointly with the membrane filter on its non-contact side with the slurry sample in order to accelerate drying of the observation samples.

In still another embodiment of the present invention, there is provided a method for evaluating the particle size distribution in a CMP slurry, which comprises viewing the samples prepared in accordance with the present invention by a scanning electron microscope.

### BRIEF DESCRIPTION OF THE FIGURES OF THE DRAWING

FIG. 1 is a photomicrograph of a fiber filter.

FIG. 2 is a photomicrograph of a membrane (iso-pore) filter.

FIG. 3 is a photomicrograph of an observation area having less than 30% of its area covered by particles.

FIG. 4 depicts the use of the membrane filter in one embodiment of the present invention.

FIG. 5 depicts the use of two membrane filters in a preferred embodiment of the present invention.

FIGS. 6 and 7 show the particle concentrations derived from the embodiment of the present invention using two iso-pore filters.

FIG. 8 shows particle concentrations in an observation area when an iso-pore filter with a pore size too large is used.

### DETAILED DESCRIPTION OF THE PREFERRED EMBODIMENTS

The present invention uses an iso-pore filter to remove most of the liquid from a CMP slurry sample. Use of a membrane filter has been found to remove the liquid from the slurry more quickly and easily compared to more conventional methods, such as the freeze dried method using a cryogenic scanning electron microscope. The process of the present invention therefore can effectively prepare a slurry sample containing abrasive particles useful for CMP for observation with a scanning electron microscope in order to monitor particle size distribution more easily and quickly than heretofore possible.

When a second membrane filter is used in the process of the present invention to wipe or smear the slurry sample over the surface of the first membrane filter, the particle concentrations in the sample to be observed can be successfully controlled. More importantly, the concentrations can be controlled so that they are useful in observations by a scanning electron microscope without the problems associated with excessive dilution, such as actually changing the characteristics of the slurry sample.

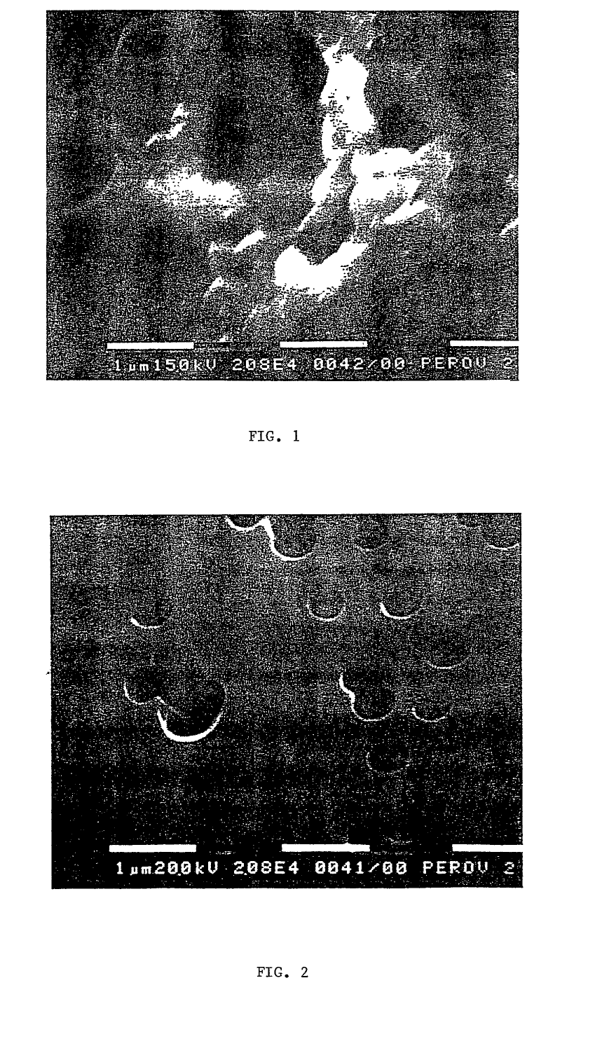

The filter used in the present process for removal of most of the liquid from the slurry in preparation for SEM observation is a membrane filter, which are well known and are commercially available. For example, suitable membrane filters are iso-pore type filters available from Millipore, e.g., the Millipore HTTP. A comparison of a membrane filter and a fiber (paper) filter demonstrates some important differences. FIG. 1 is a photomicrograph of a fiber filter, and FIG. 2 is a photomicrograph of an iso-pore type filter. For the fiber type filter a Millipore VMWP was used, and the iso-pore type filter was a Millipore HTTP.

The surface of the fiber type filter is quite complicated. Ball like structures are observed, making it more difficult to observe a sample particle. Also a charging occurs if more than 15 kV acceleration potential is used. As a result, higher magnification observations are more difficult.

In comparison, the iso-pore type filter gives a simple surface structure, and there is no charge up until 25 kV acceleration potential. Therefore, the iso-pore type filter is the filter of the present invention.

It is important to have a suitable range of particle concentration in an observation area. If the particle concentration is too high, it is difficult to understand the size of each particle and the form of each agglomeration of particles. On the other hand, if the particle concentration is too low, it is difficult to find a particle. As well, too much dilution can change the characteristics of a sample slurry.

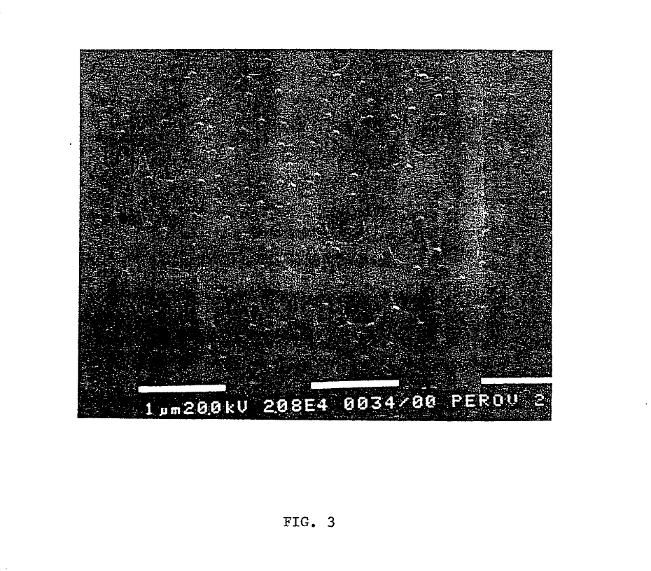

FIG. 3 shows an example of a suitable range of particle concentration in the observation area. It is easy to understand the relationship of each particle and size. A suitable range of particle concentration in the observation area should be such that less than 30% of the area is covered by particles. The lower limit of particle concentration is that practical, with about 5% or greater generally preferred.

The concentration range of the particles is therefore important in order to get an interesting image by SEM. Sometimes a sample needs to be diluted, particularly slurry samples of very fine particles such as silicon oxide and aluminum oxide particles. The dilution factor of the sample is a maximum of 1000 times. A greater dilution factor would change the slurry characteristics.

FIG. 4 shows a process using an iso-pore filter in accordance with the present invention. Preferably, the iso-pore filter is placed on a paper filter and 20 μl of a diluted sample slurry is placed dropwise onto the iso-pore filter. The paper filter is preferred as it works as a blotter to expedite the drying or removal of liquid from the sample slurry. The use of a filter in accordance with FIG. 4 allows one to prepare a suitable slurry sample for SEM observation by removing the liquid quickly and easily.

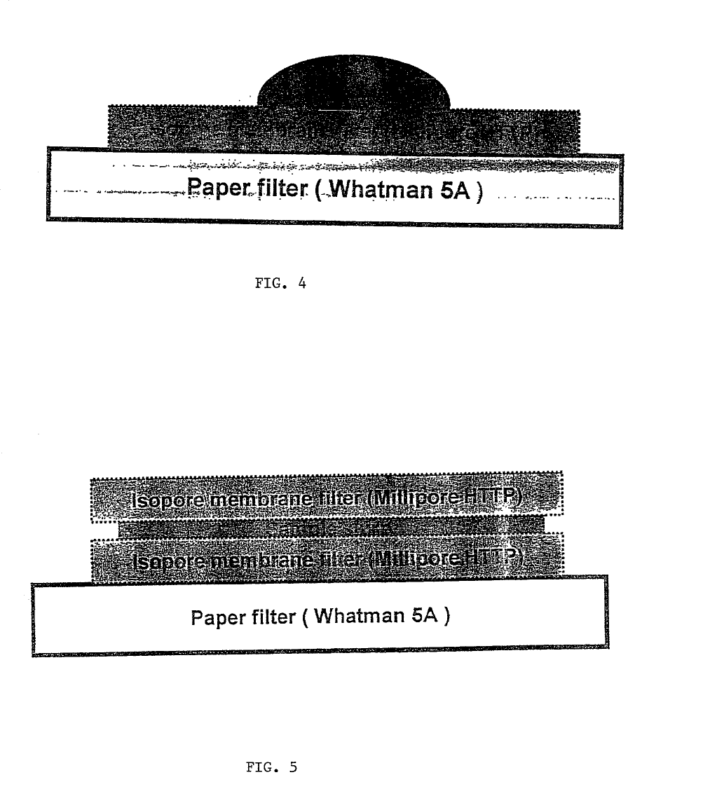

FIG. 5 depicts a preferred embodiment utilizing two iso-pore filters.

In FIG. 5, the sample droplet on the bottom iso-pore filter is covered by another iso-pore filter, with the sample being wiped or smeared between the bottom filter and the upper filter. Preferably, a paper filter is used with each iso-pore filter to help in drying the samples. The result of wiping the sample between the filters is the creation of samples for observation on both the bottom and top filters of different particle concentrations.

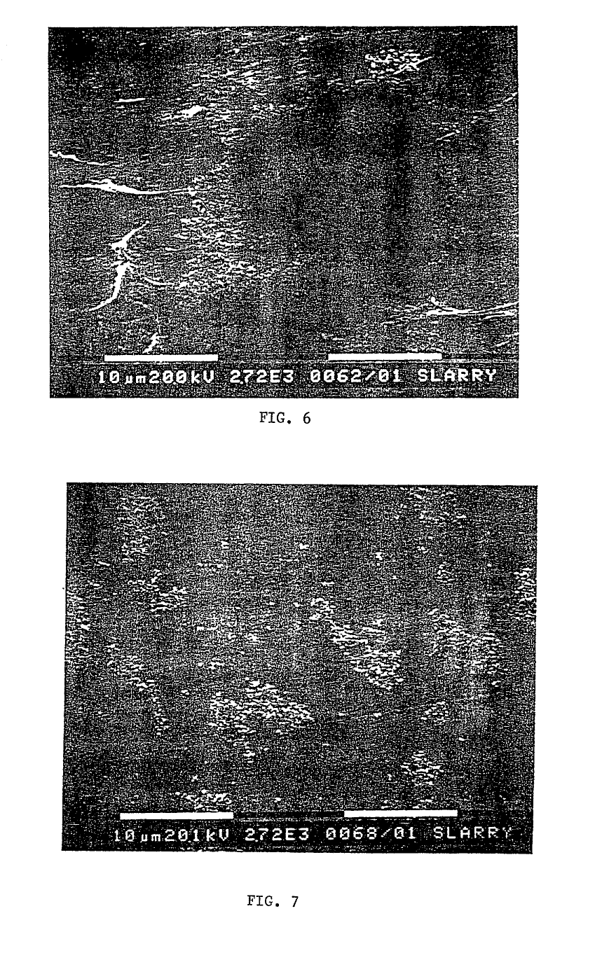

The bottom filter gives a higher concentration of particles than the upper filter. It is convenient to make different concentration samples from a single concentration sample solution, and this is an advantage of the present invention. FIGS. 6 and 7 show the difference in particle concentration between the bottom and the upper filters, respectively, from the same sample solution. FIG. 6 shows the bottom filter image, which has a very high particle concentration area in which analysis of the individual particles is difficult. On the other hand, FIG. 7 shows scattered particles in the image, in which the particle concentration is suitable.

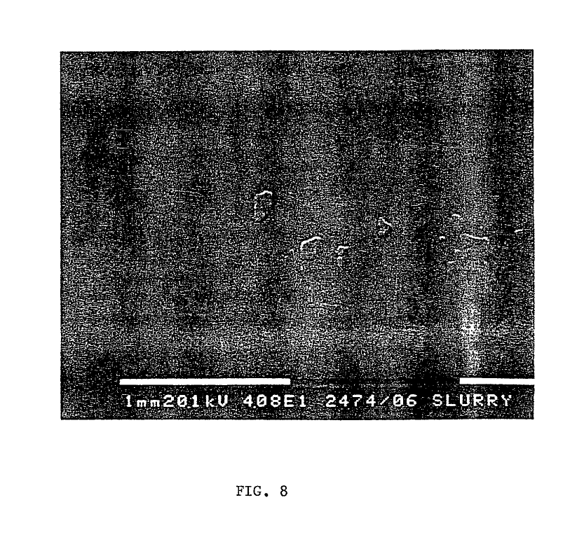

There are many iso-pore type filters of different pore sizes on the market. When a larger pore size filter is applied, the drying time is shorter. However the flow rate of a sample solution passing through the pores is also much higher, and many particles are lost with the solution. Use of such a large pore size filter results in a particle concentrated area such as shown in FIG. 8. It can be difficult to get a suitable range of particle concentration, but it has been found that when the pore size is less than 3 times that of the particle size, a suitable concentration is obtained.

For dilution purposes, the same solution as the matrix of the sample should be used. However this can be time consuming or difficult. So the use of DI water (18 m-ohm/cm and filtrated water) for dilution was compared to the use of a matrix solution. The sample slurries were dried in accordance with FIG. 4, using a single iso-pore filter, and a paper filter as a blotter.

In the case of dilution with a matrix solution, there appears some crystals from a salt which is contained in the matrix solution. The crystals make it difficult to observe the particles. On the other hand, the DI water diluted sample shows no crystals. Thus, use of DI water as a diluent is appropriate.

DI water and matrix dilution samples were prepared and dried using the techniques of FIG. 5. No crystals were observed in the image of the matrix solution samples. Actually, there is no significant difference between the DI water and matrix dilution samples. Using DI water as a diluent is also appropriate when utilizing the two filter technique of FIG. 4.

The methods of the present invention are applicable to the preparation of a CMP slurry sample for SEM observation/analysis. The present methods allow the preparation to be easy, quick and effective, without the need for complicated equipment such as a cryogenic SEM.

While the invention has been described in terms of preferred embodiments, the skilled artisan will appreciate that various modifications, substitutions, omissions and changes may be made without departing from the spirit thereof. Accordingly, it is intended that the scope of the present invention be limited solely by the scope of the following claims, including equivalents thereof.

What is claimed is:

1. A process of preparing a slurry sample containing abrasive particles useful in CMP for observation with a scanning electron microscope in order to monitor particle size distribution, the process comprising
providing a slurry containing abrasive particle useful in CMP, and
placing a sample of the slurry on an iso-pore filter, thereby removing liquid from the slurry.

2. The process of claim 1, wherein the slurry has been diluted a maximum factor of 1000 times prior to using the iso-pore filter.

3. The process of claim 1, wherein a sample of the slurry is placed onto the iso-pore filter, the sample being covered by another iso-pore filter so that the sample is between a bottom and a top iso-pore filter, and then smearing the sample between the two filters to thereby create samples on the bottom filter and on the top filter of different particle concentration.

4. The process of claim 1, wherein a blotter medium is used beneath the iso-pure filter to accelerate drying of the observation sample in the iso-pore filter.

5. The process of claim 4, wherein the blotter medium is a paper filter.

6. The process of claim 1, wherein the abrasive particles contain silicon oxide, aluminum oxide and/or cerium oxide particles.

7. The process of claim 1, wherein the resulting slurry sample on the iso-pore filter provides an observation area where less than 30% of the area is covered by particles.

8. The process of claim 1, wherein the pore sizes of the iso-pore filter is less than three times than that of the average particle size.

9. A process of preparing a slurry sample containing abrasive particles useful in CMP for observation with a scanning electron microscope in order to monitor particle size distribution, the process comprising
providing a slurry of abrasive particles useful in CMP,
diluting a sample of the slurry to a maximum of 1000 times, placing some of the diluted slurry sample onto a bottom iso-pore filter, covering the sample with a top iso-pore filter, and then smearing the droplet between the two filters to thereby create samples for observation on the bottom and top filters of different particle concentrations.

10. The process of claim 9, wherein a blotter medium is used on the non-contact side of each of the bottom and top filters in order to accelerate drying of the observation samples on the iso-pore filters.

11. The process of claim 10, wherein the blotter medium is a paper filter.

12. The process of claim 9, wherein the particles comprise silicon oxide particles.

13. The process of claim 9, wherein the particles comprise aluminum oxide and/or cerium oxide particles.

14. The process of claim 9, wherein at least one of the resulting slurry samples on the bottom and top filters provides an observation area where less than 30% of the area is covered by particles.

15. A process for evaluating the particle size distribution in a CMP slurry, which comprises preparing a slurry sample by the method of claim 1, and then viewing the sample with a scanning electron microscope.

16. A process for evaluating the particle size distribution in a CMP slurry, which comprises preparing a slurry sample by the method of claim 4, and then viewing the sample with a scanning electron microscope.

17. A process for evaluating the particle size distribution in a CMP slurry, which comprises preparing a slurry sample by the method of claim 7, and then viewing the sample with a scanning electron microscope.

18. A process for evaluating the particle size distribution in a CMP slurry, which comprises preparing a slurry sample by the method of claim 9, and then viewing the sample with a scanning electron microscope.

19. A process for evaluating the particle size distribution in a CMP slurry, which comprises preparing a slurry sample by the method of claim 10, and then viewing the sample with a scanning electron microscope.

20. A process for evaluating the particle size distribution in a CMP slurry, which comprises preparing a slurry sample by the method of claim 14, and then viewing the sample with a scanning electron microscope.
